(19) United States
(12) Patent Application Publication
(10) Pub. No.: US 2026/0361678 A1
(43) Pub. Date: Nov. 12, 2026

(54) APPLICATION SERVICE METHODS AND SYSTEMS AFFECTING THE EDGE OF A NETWORK

(71) Applicant: Yue HE, Burnaby (CA)

(72) Inventor: Yue HE, Burnaby (CA)

(21) Appl. No.: 19/719,037

(22) Filed: Jun. 24, 2026

Related U.S. Application Data
(63) Continuation-in-part of application No. PCT/CN2024/142385, filed on Dec. 25, 2024.
(60) Provisional application No. 63/614,656, filed on Dec. 25, 2023.

(51) Int. Cl. H04L 61/2592; H04L 61/4511; H04L 61/5061; H04L 101/668

(52) U.S. Cl. CPC H04L 61/2592; H04L 61/4511; H04L 61/5061; H04L 2101/668

(57) ABSTRACT

The present disclosure relates to the field of edge computing. Provided are a network edge application service system, comprising: a system self-owned subnet address pool, which allocates a unique subnet address to an application service provider and an edge service provider, wherein a fixed Internet address is provided to the application service provider, and the Internet address is provided to the edge service provider; and a network tunnel, which is established on the basis of the subnet address and the Internet address. A request data packet of a terminal is sent to a dispatcher subnet address of the application service provider, a dispatcher receives the request data packet to perform processing, configures a reply data packet to be redirected to a server subnet address of the edge service provider, and transmits the reply data packet to the terminal; and a second request data packet of the terminal is sent to the server subnet address, so as to acquire data content. An address is allocated to a mobile terminal by means of a fixed private network or public network address pool, so that high public network subnet costs are avoided, and the network operation and maintenance management is simplified by means of tunnel technology, thereby reducing delays caused by updating and convergence of a routing table. Methods related to these functions are likewise described above.

### RELATED APPLICATION

The present bypass continuation-in-part claims priority to international application PCT/CN2024/142385, which is incorporated herein to the extent not inconsistent herewith.

### TECHNICAL FIELD

The present invention relates to the field of edge computing, and in particular to application service methods and systems affecting the edge of a network.

### BACKGROUND

Traditional network architecture usually uses fixed public network address pools and subnets to allocate IP addresses to mobile routers and mobile terminals. At the same time, the operator network manages routing through the internal gateway protocol IGP and the border gateway protocol BGP to ensure effective communication inside and outside the network. However, with the use of mobile devices and mobile servers, mobile servers will obtain different IP addresses when accessing the Internet at different locations. Due to the change of this dynamic IP address, the traditional network architecture cannot effectively cope with the continuous connection and stable service between mobile servers and terminals.

Although the mobile server can establish a connection with the fixed IP server on the Internet and initiate a request to it, the fixed IP server can only respond to the request initiated by the mobile server because the IP address of the mobile server is constantly changing. Since the fixed IP server cannot track the constantly changing IP address of the mobile server, it cannot actively establish a connection with the mobile server and obtain the mobile server's information. Therefore, the mobile server cannot provide APP services on the Internet to the mobile terminal.

### SUMMARY

Based on the high cost and complex operation and maintenance problems of maintaining a fixed public network subnet address pool in the prior art, especially the significant transmission delay caused by frequent routing information updates in a mobile environment, and the complexity of synchronous updating of multi-node content sources, an efficient network edge application service system is proposed. One or more purposes of the present invention may be achieved through respective parts of the following technical solutions.

The present disclosure provides application service systems at the edge of a network, some comprising an application service provider and an edge service provider; the system has its own subnet address pool, and allocates unique and fixed subnet address scopes from the address pool to the application service provider and the edge service provider; the application service provider is provided with a fixed Internet address, and the edge service provider is provided with an Internet address, and at the same time, the gateways of the application service provider and the edge service provider are configured with a network address translation, which is used for address translation between the subnet address and the Internet address;

An edge service provider may include terminals, servers and gateways, and internal communications are based on the fixed subnet address scope of the edge service provider. An application service provider may include a server, a dispatcher, and a gateway, with internal communications being performed based on the fixed subnet address scope of the application service provider;

In one variant a network tunnel is established based on subnet addresses and Internet addresses on an application service provider and an edge service provider. The network tunnel includes an internal route. The internal route adopts a tunnel binding strategy intranet. It operates on a data packet whose destination address and source address are subnet addresses. The tunnel source address end encapsulates the data packet in the tunnel for transmission. The tunnel destination address end decapsulates the data packet into a data packet whose destination address and source address are subnet addresses. When the edge service provider's internet address changes, the network tunnel parameters are adjusted and the internal route is rebuilt. The tunnel source address end and the tunnel destination address end include an application service provider and an edge service provider.

Based on internal routing and internal communication, the terminal's request data packet is sent to the dispatcher subnet address of the application service provider through internal routing. The dispatcher receives the request data packet for processing and sets the reply data packet to redirect to the server subnet address of the edge service provider, and transmits it to the edge provider's terminal through internal routing. The terminal's second request data packet is sent to the corresponding server subnet address based on the internal communication of the edge service provider to obtain the data content cached in the server.

Further, it also includes an application source, the application source has an Internet address, and preloads data content to a server of an application service provider, and the server of the application service provider preloads the data content to a server of an edge service provider; a server of an application service provider and a server of an edge service provider cache data content of an application source;

The network tunnel also includes an external route, such as split tunnel of VPN, IPsec, which uses a tunnel binding strategy external network to process a data packet whose destination address or source address is an application source Internet address. The tunnel source address end encapsulates the data packet in the tunnel and sends it, and decapsulates the data packet at the tunnel destination address end as a data packet whose destination address or source address is an application source Internet address. When the destination address or source address in the network tunnel of the edge service provider's internet address changes, the network tunnel parameters are adjusted and the external route is rebuilt; wherein, the tunnel source address end and the tunnel destination address end include an application source service provider and an edge service provider;

The application source is provided with a dispatcher, which is used to redirect the request to the corresponding dispatcher subnet address of the application service provider in response to the terminal requesting data content through the network tunnel. The terminal requests the corresponding data content according to the dispatcher subnet address of the redirected application service provider, including:

The terminal of the edge service provider sends a request data packet to the application source to obtain the data content in the application source; the request data packet is routed via external route to the application service provider, and the application service provider converts the source address of the request data packet into the Internet address of the application service provider and sends it to the application source; the application source sets the reply data packet to redirect to the dispatcher subnet address of the application service provider through the internally set dispatcher, and the reply packet reaches the application service provider; it reaches the terminal through the network address translation and external routing of the application service provider.

Furthermore, the dispatcher of the application service provider stores and records the subnet address and server subnet address of the edge service provider; the dispatcher matches the subnet address of the corresponding edge service provider according to the source address of the request data packet, obtains the corresponding server subnet address of the edge provider, and is used to set the reply data packet to redirect to the server subnet address of the edge service provider, and returns the reply data packet through internal routing and the edge service provider.

Furthermore, when the edge service provider's server does not contain the data content requested by the terminal, it requests the data content from the upstream application service provider's server through internal routing. The application service provider's server responds to the request and forwards the data content to the edge service provider's server through internal routing to respond to the second request data packet of the terminal.

Further, the dispatcher of the application source is used to record the data content preloaded to the server of the application service provider, and record the Internet address of the application service provider and the corresponding dispatcher subnet address;

After the application source matches the data content requested by the request data packet with the server content preloaded into the application service provider, it matches the source address of the request data packet with the Internet address of the application service provider, obtains the corresponding dispatcher subnet address of the application service provider, sets the reply data packet to redirect to the dispatcher subnet address of the application service provider, and returns the reply data packet to the application service provider; when the data content requested by the request data packet of the application source does not match the server content preloaded into the application service provider, it returns the corresponding data packet to the application service provider.

Furthermore, the application service provider is also used to manage the allocation of subnet address pools; the network address translation configured by the application service provider's gateway is used to convert the terminal's subnet address into the application service provider's Internet address, or to convert the application service provider's Internet address into the corresponding terminal's subnet address.

Furthermore, the application service provider and the edge service provider are also configured with corresponding DNS servers and equipped with application source records for recording the Internet address of the application source, the Internet address including the application source domain name and IP address;

The application source record in the DNS server of the application service provider is transmitted to the DNS server of the edge service provider manually or automatically, and is used by the gateway of the application service provider and the edge service provider to encapsulate the request data packet whose destination address is the Internet address of the application source record and send it through an external route; at the same time, when the terminal sends a request data packet for the domain name of the application source, the DNS server of the edge service provider searches for the IP address corresponding to the application source domain name.

Furthermore, it also includes a second application source, a dedicated second server and a second dispatcher of the application service provider, and a dedicated second server of the edge service provider; wherein
The second application source preloads data content to a dedicated second server of the application service provider, and the dedicated second server preloads data content to a dedicated second server of the edge service provider;
The dispatcher of the second application source records the Internet address of the application service provider and the subnet address of the second dispatcher; the second dispatcher records the subnet address of the edge service provider and the second server subnet address of the edge service provider;
At the same time, a tunnel binding strategy is adopted to establish a second external route based on a data packet whose destination address or source address is the Internet address of the second application source. The source address end encapsulates the data packet in a tunnel and sends it, and decapsulates the data packet into a data packet whose destination address or source address is the Internet address of the second application source through the network conversion address of the gateway at the destination address end of the tunnel, wherein the tunnel source address end and the tunnel destination address end include an application source service provider and an edge service provider.

Furthermore, the request data packet sent by the terminal to the second application source reaches the gateway of the application service provider through the second external route, and after decapsulation, it is converted into the Internet address of the application service provider through the network address translation and reaches the second application source through the Internet; and the second application source record is set in the DNS server of the application service provider, which is transmitted to the DNS server of the edge service provider manually or automatically.

Furthermore, the edge service provider is provided with multiple network connection interfaces and is configured with corresponding network addresses, wherein the network connection interfaces include WiFi, Ethernet and satellite 4/5G networks, wherein WiFi and Ethernet are used to connect to high-speed fiber-optic Internet, and satellite 4/5G networks are used to connect to low-speed Internet. At the same time, the network connection interface for connecting to high-speed fiber-optic Internet is given priority.

Furthermore, the system also includes an external server for caching the server content of the application service provider, wherein:
Edge service providers have records of associations between network addresses connected to high-speed fiber-optic Internet and external server addresses;
The edge service provider also records the association between the geographic location information and the external server address;
Based on any one of the items matching the corresponding external server address according to the network address and the associated record, the edge service provider server synchronously updates the data content with the external server through the network connection interface.

Furthermore, the server of the edge service provider sends a request data packet based on the subnet address through the gateway of the edge server to the external server. Based on the fact that the external server does not match the network tunnel, the source address of request is converted into the network address of the network connection interface connected to the high-speed fiber-optic Internet through the network address translation of the gateway, and then the request data packet is sent to the corresponding external server address for the server content update of the edge service network provider.

Furthermore, the external server is provided with an Internet address, and the domain name and IP address are registered in the DNS server. After the edge service provider's server obtains the network address of the network connection interface connected to the high-speed fiber-optic Internet based on the gateway, it searches the DNS server for the domain name to which the external server belongs and finds the corresponding IP address of the external server.

Furthermore, it also includes a second edge service provider, which is connected to the high-speed fiber-optic Internet and has a fixed or dynamic network address; the gateway of the second edge service provider is connected to the gateway of the edge service provider via WIFI, and the edge service provider obtains the subnet address of the second edge service provider, connects to the internal routing of the high-speed fiber-optic Internet and the application service provider, and the subnet address of the server of the second edge service provider in the association record of the external server is the external server address.

Further, the server of the second edge service provider responds to the request data packet for content update of the server of the edge service provider, the gateway of the edge service provider converts the source address of the request data packet to the subnet address of the edge service provider at the second edge service provider through network address translation, and sends the request data packet to the gateway of the second edge service provider;

At the gateway of the second edge service provider, the destination address of the request data packet is the server subnet address of the second edge service provider, and the source address is the subnet address of the edge service provider at the second edge service provider. Based on the internal routing that does not match the tunnel of the second edge service provider, the data packet is sent to the second edge server subnet address; the server of the edge service provider obtains the server content update of the second edge service provider.

Furthermore, the edge service provider's gateway sets the network interface route connected to the high-speed fiber-optic Internet with priority; the system rebuilds the high-speed tunnel, high-speed internal route and high-speed external route; the edge service provider's gateway sets the network interface route priority connected to the high-speed fiber-optic Internet with the same priority, and the tunnel uses the original network interface address parameters to keep the tunnel, internal route and external route consistent.

Some variants of the present invention allocate addresses to mobile server terminals by using fixed private or public network address pools, thus avoiding high public network subnet fees, and simplifies network operation and maintenance management through tunnel technology, reducing the delay caused by routing table updates and convergence. Specifically, the mobile terminal uses the private or public network address allocated by the operator without occupying the fixed public network subnet address pool, thereby significantly reducing operating costs. In the operator network, the use of tunnel technology avoids the establishment of traditional routes, simplifies operation and maintenance management, reduces delays and improves network efficiency.

Some variants comprise sending, by a terminal of an edge service provider, a first request packet toward an application source through an external route of a network tunnel; translating, by an application service provider, a source address of the first request packet by network address translation and forwarding the first request packet to the application source; returning, by the application source, a first reply packet identifying a first redirection destination; sending, by the terminal, a second request packet to the first redirection destination through an internal route of the network tunnel; returning, by a dispatcher of the application service provider, a second reply packet identifying an edge server of the edge service provider as a second redirection destination; and sending, by the terminal, a third request packet to the edge server to obtain cached data content.

Compared with the traditional internal gateway protocol (IGP) or border gateway protocol (BGP), some variants of the present invention reduce the delay and support real-time data transmission by dynamically allocating private network or public network addresses and automatically rebuilding tunnels in a mobile environment. Through tunnel technology, the data sent by the terminal to the content source is directly processed by the content source and redirected to the nearest mobile server through dispatchering, thereby reducing the data transmission path, reducing the delay and improving the transmission efficiency.

### BRIEF DESCRIPTION OF THE DRAWINGS

Other features, objects and advantages of the present disclosure will become more apparent from the detailed description of non-limiting embodiments made with reference to the following drawings:

FIG. 1 is a structural diagram of a first component of a single application source in an embodiment of the present invention;

FIG. 2 is a second component structure diagram of a single application source in an embodiment of the present invention;

FIG. 3 is a third component structure diagram of a single application source in an embodiment of the present invention;

FIG. 4 is a diagram of a request processing process of a single application source in an embodiment of the present invention;

FIG. 5 is a flowchart of a request process of a single application source in an embodiment of the present invention, wherein FIG. 5a is the first part of the flowchart, and FIG. 5b is the second part of the flowchart continuing from FIG. 5a;

FIG. 6 is a structural diagram of a first component of adding a DNS server to a single application source in an embodiment of the present invention;

FIG. 7 is a diagram of a request processing process for adding a DNS server to a single application source in an embodiment of the present invention;

FIG. 8 is a first component structural diagram of multiple application sources in an embodiment of the present invention;

FIG. 9 is a second component structure diagram of multiple application sources in an embodiment of the present invention;

FIG. 10 is a structural diagram of a dedicated server and a first component of a dedicated server used by an application source in an embodiment of the present invention;

FIG. 11 is a second component structure diagram of an application source using a dedicated server and a dispatcher in an embodiment of the present invention;

FIG. 12 is a diagram of a first component architecture of an ESP including a second ESP in an embodiment of the present invention;

FIG. 13 is a diagram of a second component architecture of an ESP including a second ESP in an embodiment of the present invention;

FIG. 14 is a diagram of a scenario application in which an ESP includes a second ESP in an embodiment of the present invention;

FIG. 15 is a diagram of a first component architecture including two ESP connections and interfaces in an embodiment of the present invention;

FIG. 16 is a diagram of a second component architecture including two ESP connections and interfaces in an embodiment of the present invention;

FIG. 17 is a diagram of a scenario application including two ESP connections and interfaces in an embodiment of the present invention;

FIG. 18 is a component architecture diagram of adding a common server in an embodiment of the present invention;

FIG. 19 is a scenario application diagram of adding a common server in an embodiment of the present invention.

### DETAILED DESCRIPTION

The present invention is described in detail below in conjunction with specific embodiments. The following embodiments will help those skilled in the art to further understand the present invention, but are not intended to limit the present invention in any form. It should be noted that, for those of ordinary skill in the art, several changes and improvements can also be made without departing from the concept of the present disclosure. These all belong to the protection scope of the present invention.

### First Embodiment

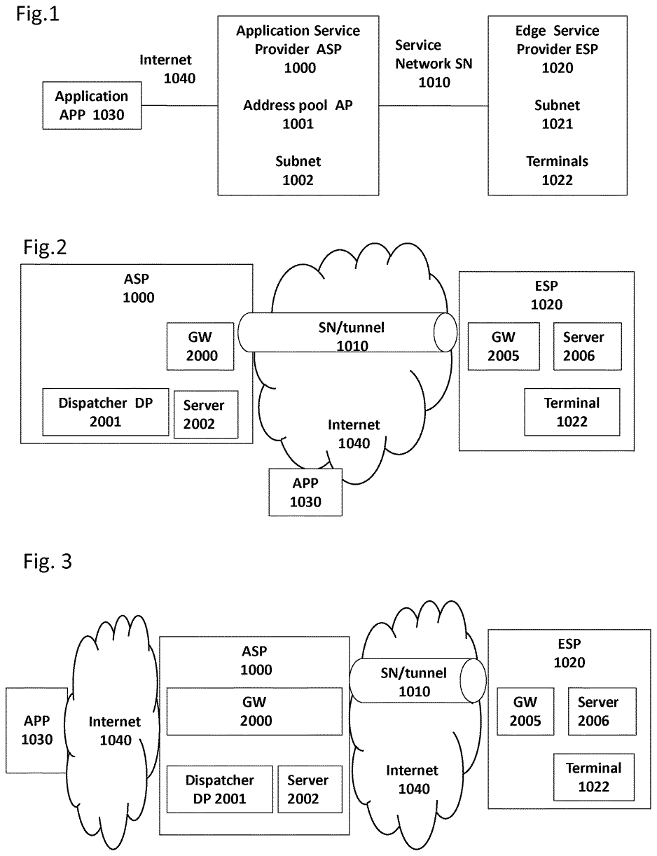

This embodiment will describe in detail how to implement the above method and system through examples, focusing on analyzing specific application situations in different scenarios, including but not limited to tunnel connection examples in different network environments: As shown in FIG. 1, the structure includes an application service provider ASP 1000, an edge service provider ESP 1020, a service network SN 1010, and an application source APP 1030; ASP 1000 is connected to ESP 1020 through the service network SN 1010, and communicates with the application source APP 1030 through the Internet 1040. ASP 1000 manages an address pool AP 1001, which has a public IP address or a private IP address, and allocates different subnet addresses to its internal devices. ASP 1000 has a unique subnet scope 1002, whose address is located in the address pool 1001 in ASP 1000. ESP 1020 is located in the address pool of ASP 1001 and has its own subnet address scope 1021. Terminal 1022 is assigned an IP address from ESP subnet scope 1021 and can communicate with ASP 1000 and APP 1030 through SN 1010. APP 1030 represents the Internet application source server, which supports applications such as voice, video, image, and games, apps, AI content, and provides interactive services with terminal 1022. The entire architecture achieves efficient data transmission and service provision through the collaborative work of ASP and ESP.

As shown in FIG. 2, ASP 1000 includes a gateway router GW 2000, a dispatcher 2001, and a server 2002. These components can be computer running programs, Docker containers, virtual machines (VMs), or bare metal devices. They can access subnet 1002 through the assigned addresses in subnet 1002.

GW 2000 is connected to the Internet 1040 and subnet 1002 through network interfaces and is responsible for routing traffic between subnet 1002, Internet 1040, and SN 1010. In FIG. 3, GW 2000 has two interfaces: one connected to the Internet 1040 and the other connected to the service network SN 1010 through the Internet 1040. The components of ESP 1020, including gateway router GW 2005, server 2006, and terminal 1022, can also be computer programs, Docker containers, virtual machines, or bare metal devices. They can be accessed in subnet 1021 using addresses assigned by the subnet. GW 2005 connects Internet 1040 and subnet 1021 through interfaces and provides routing functions to ensure data flow between subnet 1021, Internet 1040, and Internet-based SN 1010.

Service network SN 1010 uses network tunneling technology such as MPLS, layer 3 VPN, vLAN, etc. to provide a reachable internal routing path from ASP 1000 subnet 1002 to ESP 1020 subnet 1021. SN/VPN 1010 provides a reachable route or path between APP 1030 IP and ESP 1020 subnet 1021 through ASP 1000, which is called external routing between APP 1030 IP and subnet 1021, such as split tunnel in VPN, IPsec.

Server 2002 of ASP 1000 preloads the contents from APP 1030, and server 2006 of ESP 1020 obtains and preloads the contents through server 2002.

The dispatcher DP 2001 has a record of the address of the subnet 1021, the address of the server 2006 in the subnet 1021. DP 2001 can be a program, a docker container, a VM virtual machine, a bare metal device, a server accessed remotely by ESP 1020 and APP 1030. ASP 1000 is connected to the Internet 1040 through the public IP address on GW 2000. The source NAT network address translation in GW 2000 is located on the Internet interface of APP 1040. ESP 1020 is connected to the Internet 1040 using the public IP address or private address from the ISP on GW 2005. The source network address translation NAT in GW 2005 is located on the Internet interface to the Internet 1040. The public IP address of ASP 1000 facing APP 1030 and the address of DP 2001 are registered on APP 1030.

APP 1030 preloads the content to server 2002 of ASP 1000, which is loaded to server 2006 of ESP 1020. APP 1030 has the content tracking record of ASP 1000 server 2002, ASP 1000 public IP address and DP 2001 address.

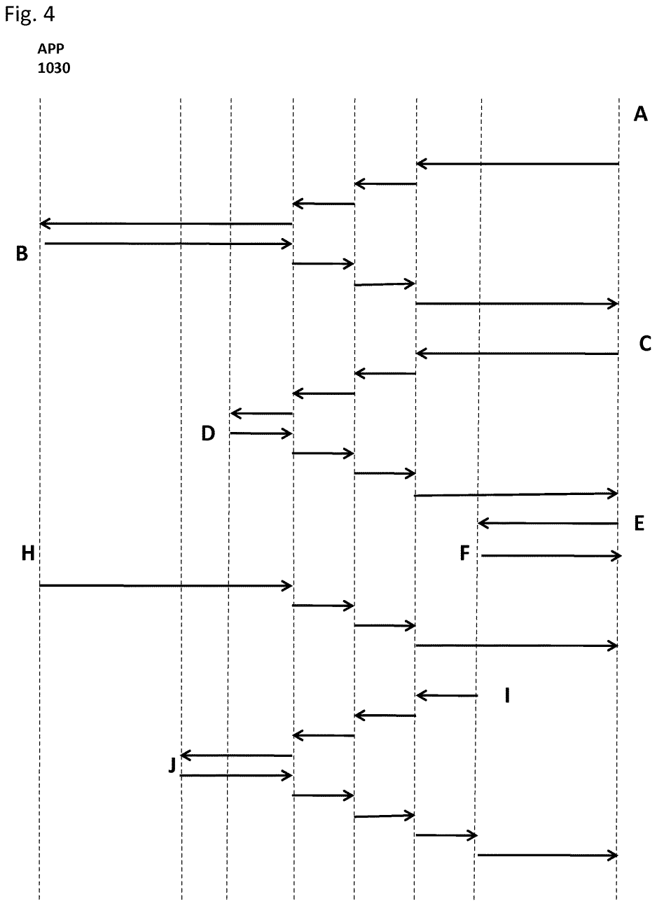

The specific request processing flow is shown in FIG. 4. In this system, the request processing flow starts when the terminal 1022 sends a request packet to the application APP 1030 in ESP 1020. This request is first received by the gateway GW 2005 of ESP, which verifies the source IP address of the packet, the terminal 1022, which is within the subnet 1021, and the destination IP address of the IP of the APP 1030 requested from 1022. These two IP addresses match the external route of SN 1010 between the IP of APP 1030 and the subnet 1021. GW 2005 sends the request packet to SN 1010, encapsulates the packet in the SN 1010 tunnel and sends it to GW 2000 in ASP 1000.

In ASP 1000, GW 2000 receives the data packet from SN 1010 tunnel, decapsulates the data packet, and recovers the source IP of terminal 1022 and the destination IP address of APP 1030 within the range of subnet 1021. GW 2000 forwards the data packet to the Internet interface 1040 to APP 1030. The source NAT on the GW 2000 interface translates the data packet source IP address to the public IP of APP 1030 to the Internet 1040 to interface.

APP 1030 receives the packet and checks the packet source IP address for a match with the registered IP address of the interface in ASP 1000 to the Internet 1040. APP 1030 checks the content record of ASP 1000 server 2002 for the requested content.

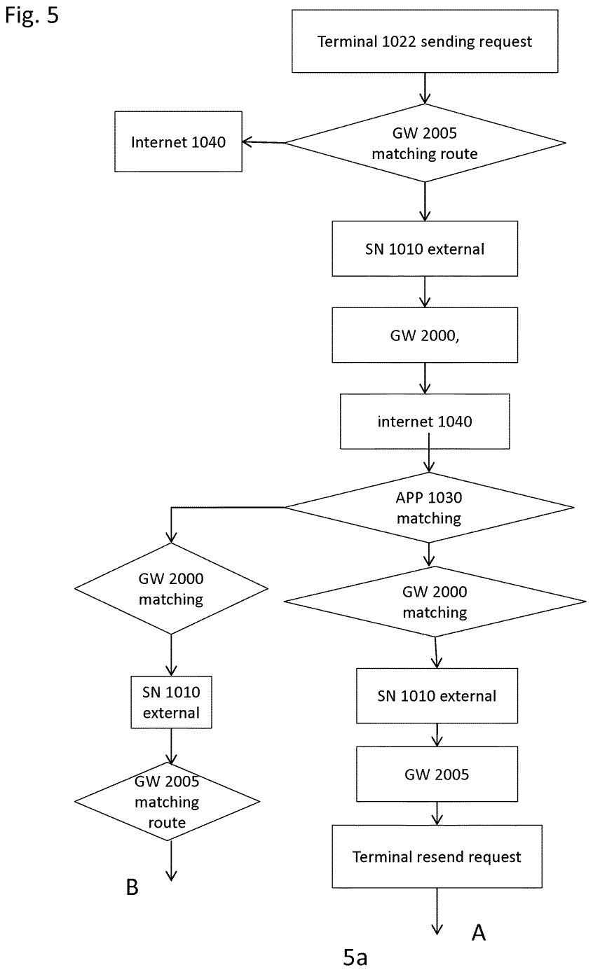

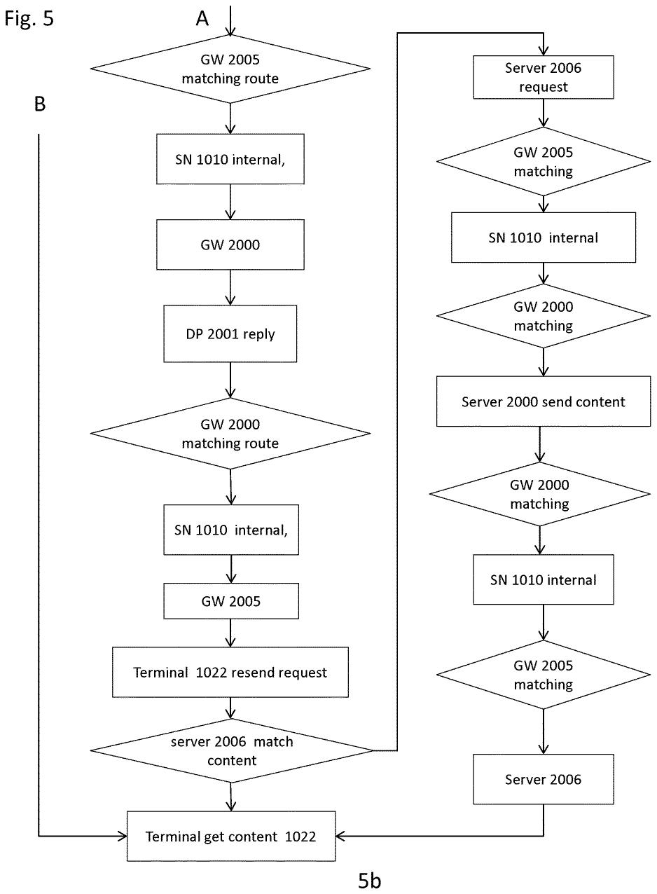

If there is the requested content in the content record, then in B of FIG. 5, APP 1030 sets the HTTP packet to be redirected to the IP address reachable by the dispatcher DP 2001 in the subnet 1002 of ASP 1000. Then, the packet is replied to ASP 1000, and the destination IP of its IP address is the public IP of GW 2000 of ASP 1000.

GW 2000 of ASP 1000 receives the packet and restores the destination IP to the IP of terminal 1022 through source NAT. GW 2000 checks that the destination IP of terminal 1022 in the packet is within the range of subnet 1021, and the source IP address is the IP of APP 1030. These two IP addresses match the external route of SN 1010. GW 2000 sends the packet to SN 1010. The packet is encapsulated in the tunnel from SN 1010 to ESP 1020.

GW 2005 of ESP 1020 receives the data packet from the SN 1010 tunnel and decapsulates the data packet into a data packet whose destination IP address of terminal 1022 is within the range of subnet 1021 and whose source IP is the IP of APP 1030. GW 2005 sends the data packet to terminal 1022.

As shown in C of FIG. 4, terminal 1022 receives the packet and processes the redirection in the HTTP packet, and resends the request packet with the destination being the IP address of dispatcher DP 2001 within the range of subnet 1002 reachable in ASP 1000, to GW 2005. GW 2005 checks that the packet source IP address is the destination IP address reachable by terminal 1022 within the range of subnet 1021, and the dispatcher DP 2001 within the range of subnet 1002. These two IP addresses match the internal route of SN 1010 between subnet 1002 and subnet 1021. GW 2005 sends the request data packet to SN 1010. The data packet is encapsulated in the SN 1010 tunnel to ASP 1000.

In ASP 1000, GW 2000 receives the data packet from SN 1010 tunnel and decapsulates the data packet into a data packet where the source IP of terminal 1022 is within the range of 1021 and the destination IP address can reach the dispatcher DP 2001.

As shown in D, DP 2001 checks that the source IP of terminal 1022 is within the range of 1021, and matches the address record of subnet 1021 to the reachable address of server 2006 in subnet 1021. DP 2001 redirects the data packet to the reachable address of server 2006 in subnet 1021 based on the source IP of terminal 1022 within the range of 1021, and replies the data packet to GW 2000.

GW 2000 checks the message and the destination IP of terminal 1022 is within the 1021 range and the source IP address can reach DP 2001. These two IP addresses match the internal route of SN 1010 between subnet 1002 and subnet 1021. GW 2000 sends the message to SN 1010. The data packet is encapsulated in the VPN 1010 tunnel to ESP 1020.

GW 2005 of ESP 1020 receives the data packet from the SN 1010 tunnel and decapsulates the data packet into a data packet whose destination IP address of terminal 1022 is within the range of subnet 1021 and whose source IP can reach DP 2001. GW 2005 sends the data packet to terminal 1022.

As shown in E of FIG. 4, terminal 1022 receives the packet and processes the redirection in http, and resends the request packet with the destination being the address in subnet 1021 reachable by server 2006 to GW 2005 in ESP 1020. Server 2006 replies to terminal 1022 with the request content preloaded from APP 1030.

In B and H, APP 1030 checks the requested content in the content record of ASP 1000 server 2002. If the requested content is not in the content record of ASP 1000 server 2002 and ESP server 2006, APP 1030 replies the content to ASP 1000. The data packet is a reply to ASP 1000, and its destination IP address is the public IP of GW 2000 of ASP 1000.

GW 2000 of ASP 1000 receives the packet and restores the destination IP to the IP of terminal 1022 through source address translation NAT. GW 2000 checks that the destination IP in the packet is terminal 1022 in the subnet 1021 range and the source IP address is the IP of APP 1030. These two IP addresses match the external route of SN 1010. GW 2000 sends the packet to SN 1010. The packet is encapsulated in the tunnel from SN 1010 to ESP 1020.

GW 2005 of ESP 1020 receives the data packet from the SN 1010 tunnel and decapsulates the data packet into a data packet whose destination IP address is the terminal 1022 within the subnet 1021 range and whose source IP is the IP of APP 1030. GW 2005 sends the data packet to the terminal 1022.

Terminal 1022 receives the packets and the content.

APP 1030 preloads the content to ASP 1000 server 2002, and server 2002 loads the content to ESP 1020 server 2006. In some cases, the content of server 2002 and server 2006 are out of sync.

As shown in E in 4, terminal 1022 receives the packet and processes the redirection in the HTTP packet, and resends the request packet with the destination being the address in subnet 1021 that can reach server 2006 to GW 2005 in ESP 1020.

If server 2006 does not have the content requested by terminal 1022, such as I, server 2006 sends the request to ASP 1000 server 2002 through the internal routing of SN 1010 between subnet 1002 and subnet 1021. For example, reverse proxy server 2006 has an HTTP upstream server address that is the address of ASP 1000 server 2002.

As J, server 2002 sends the content to server 2006 via the internal routing of SN 1010 between subnet 1002 and subnet 1021.

GW 2005 of ESP 1020 receives the data packet from the SN 1010 tunnel and decapsulates the data packet into a data packet whose destination IP address is the address of server 2006 within the range of subnet 1021 and whose source IP is the IP of server 2002 in ASP 1000. GW 2005 sends the data packet to server 2006.

The server 2006 forwards the data to the terminal 1022. The terminal 1022 receives the packets and the content.

Throughout the entire process, internal and external routing, tunneling technology, and source NAT translation critically support the correct transmission and routing of data packets, ensuring the efficiency and accuracy of request and response content.

The following is explained in conjunction with FIG. 5. The terminal 1022 sends a request to obtain the content of the application APP 1030. The request first reaches the ESP gateway GW 2005. GW 2005 matches the route and sends the request to the ASP gateway GW 2000 through the external route of SN 1010. After GW 2000 receives the request data packet, the source NAT on the GW 2000 interface converts the source IP address of the data packet to the public IP of the interface from APP 1030 to the Internet 1040, passes the request to the Internet 1040, and finally reaches the application source APP 1030.

APP 1030 searches for the content, and checks the cache to see if the requested content exists in the ASP recorded in the APP 1030. When the requested content is not cached in the ASP server recorded in the APP 1030, the APP 1030 sends the content to the GW 2000. At this time, the GW 2000 receives the packet and restores the destination IP to the IP of the terminal 1022 through the source address translation NAT. The uncached requested content is returned to the terminal 1022 through the matching external routes of the GW 2000 and GW 2005 and the external routes of the SN 1010.

When the ASP server recorded by APP 1030 has the request content cached, APP 1030 matches the source address of the request packet with the Internet address of ASP 1000, finds the IP address reachable by the dispatcher DP 2001 in the subnet 1002 of ASP 1000, and APP 1030 sets the packet to be redirected to the IP address reachable by the dispatcher DP 2001 in the subnet 1002 of ASP 1000. Then, the packet is replied to ASP 1000, and the destination IP of its IP address is the public IP of GW 2000 of ASP 1000. GW 2000 of ASP 1000 receives the packet and restores the destination IP to the IP of terminal 1022 through source NAT. GW 2000 checks that the destination IP terminal 1022 in the packet is within the range of subnet 1021, and the source IP address is the IP of APP 1030. These two IP addresses match the external route of SN 1010. GW 2000 sends the data packet to SN 1010. The data packet is encapsulated in the tunnel from SN 1010 to ESP 1020. GW 2005 of ESP 1020 receives the data packet from the SN 1010 tunnel and decapsulates the data packet into a data packet whose destination IP address of terminal 1022 is within the range of subnet 1021 and whose source IP is the IP of APP 1030. GW 2005 sends the data packet to terminal 1022.

Terminal 1022 receives the packet and processes the redirection in the HTTP packet, and resends the request packet with the destination being the IP address of the dispatcher DP 2001 within the range of subnet 1002 reachable in ASP 1000, through the internal routing of GW 2005 and SN 1010 of GW 2000, reaching GW 2000, DP 2001. DP 2001 checks that the source IP of terminal 1022 is within the range of 1021, and matches the address record of subnet 1021 with the address reachable by server 2006 in subnet 1021. DP 2001 redirects the data packet to the reachable address of server 2006 in subnet 1021 according to the source IP of terminal 1022 in the range of 1021, and replies the data packet to GW 2000. Through the internal route matching of SN 1010, GW 2005 receives the data packet from the SN 1010 tunnel and decapsulates the data packet into a data packet whose destination IP address of terminal 1022 is in the range of subnet 1021 and whose source IP is reachable to DP 2001. GW 2005 sends the data packet to terminal 1022.

Terminal 1022 resends a request packet to GW 2005 in ESP 1020, with the destination being an address in subnet 1021 reachable by server 2006. Server 2006 replies to terminal 1022 with the request content preloaded from APP 1030.

When server 2006 does not pre-cache the requested content, server 2006 sends the request to ASP 1000 server 2002 via the internal routing of SN 1010 between subnet 1002 and subnet 1021. Server 2002 sends the content to server 2006 via the internal routing of SN 1010 between subnet 1002 and subnet 1021. Server 2006 receives, cache and forwards the data to terminal 1022. Terminal 1022 receives the packet and the content.

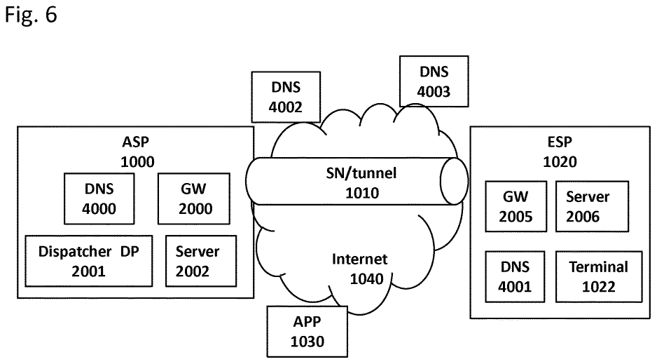

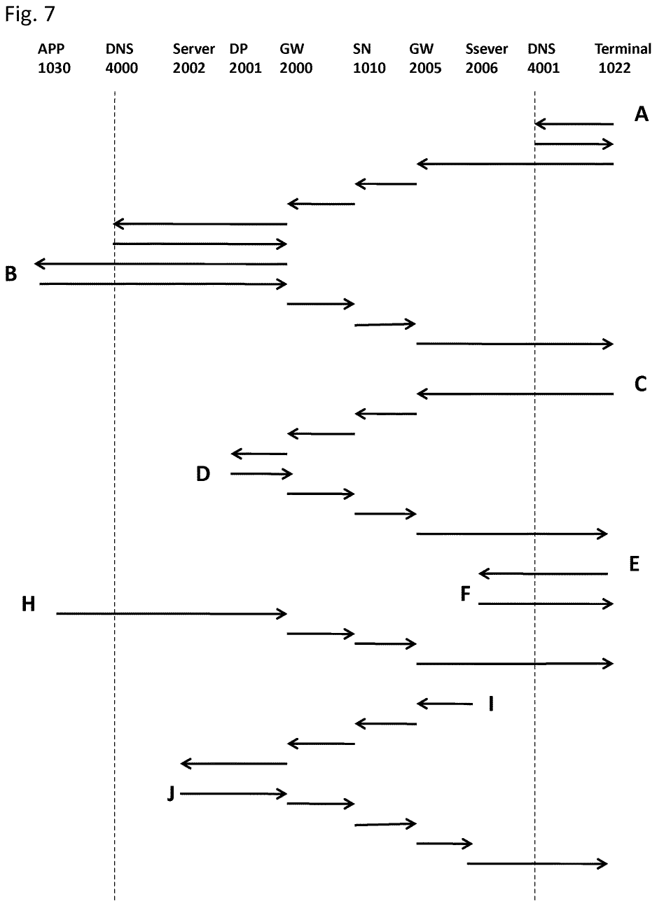

To elaborate on the functions of request processing in a system that includes a DNS server, we will explore the architecture and flow of FIGS. 6 and 7. These figures show an enhanced network architecture that includes an application service provider ASP and an edge service provider ESP, which are interconnected through a service network SN and interact with applications APP on the Internet. This architecture particularly emphasizes the role of DNS servers, which are located at key nodes of the network to support domain name resolution and optimize network request paths.

In FIG. 6, we see an extended network system that includes four key DNS servers located close to the ASPs and ESPs in the Internet. This system design takes into account network efficiency and optimized domain name resolution process:

DNS 4003 server is close to ESP 1020 in Internet 1040, DNS 4001 is in ESP 1020, DNS 4002 server is close to ASP 1000 in Internet 1040, and DNS 4000 is in ASP 1000. APP 1030 is a server whose public IP address and domain name are registered on DNS 4002 and 4003. ASP 1000 includes GW 2000, dispatcher 2001, server 2002, and DNS 4000. ASP can be a computer running a program, a docker container, a VM virtual machine, or a bare metal device, including GW 2000, dispatcher 2001, server 2002, and DNS 4000. They can be in subnet 1002 or addresses allocated from subnet 1002.

ASP 1000 is connected to Internet 1040 through a public IP address on GW 2000, and DNS 4002 is assigned to DNS 4000 as a remote DNS server. ESP 1020 includes GW 2005, server 2006, DNS 4001, and terminal 1022. ESP 1020 can be a computer running a program, docker capacity, VM virtual machine, bare metal device, including GW 2005, S server 2006, DNS 4001, and terminal 1022. They are reachable in subnet 1021. Or the address assigned from subnet 1021.

ESP 1020 is connected to Internet 1040 using a private or public IP address from the ISP on GW 2005, and DNS 4003 is assigned to DNS 4001 as a remote DNS server. Source NAT in GW 2005 is located on the Internet interface to Internet 1040. APP 1030 has registered a public IP address and domain name in DNS 4002, 4003. DNS 4000 can obtain the IP and domain name of APP 1030 from DNS 4002. The IP and domain name of APP 1030 are obtained from DNS 4002 and manually or automatically transferred to DNS 4001 of ESP 1020 for setting. The method of setting DNS 4001 can be to set the hosts file hosts with IP and domain name on the Linux system, or to set the local DNS on the server on ESP 1020. ESP 1020 can obtain the IP and domain name of APP 1030 from DNS 4001. APP 1030 preloads content to ASP 1000 server 2002, which is loaded to ESP 1020 server 2006. APP 1030 has content tracking records in ASP 1000 server 2002, ASP 1000 public network IP address, and DP 2001 address. This configuration optimizes the network path, reduces domain name resolution time, and ensures that data packets can be transmitted to the destination quickly and accurately.

FIG. 7 illustrates in detail the processing flow in a network request with a DNS server. Compared to the previous configuration, this flow includes an additional step for domain name resolution to ensure the validity and efficiency of the network request: In ESP 1020, terminal 1022 sends a request packet with a domain name of APP 1030. ESP 1020 DNS 4001 obtains the IP address of APP 1030. The request for the IP of APP 1030 is sent to GW 2005. GW 2000 receives the packet from the SN 1010 tunnel, decapsulates the packet, and recovers the source IP of terminal 1022 within the range of subnet 1021, and the destination IP address of APP 1030. GW 2000 forwards the packet to the interface of Internet 1040 to APP 1030. GW 2000 can obtain confirmation of the IP of APP 1030 from DNS 4000 through reverse DNS and ptr check and forward the packet. Source NAT on the interface of GW 2000 converts the source IP address of the data packet of terminal 1022 to the public IP of the interface of APP 1030 to the Internet 1040. This process not only ensures effective access to the destination application, but also optimizes the data transmission path, reduces network latency, and improves the overall network performance.

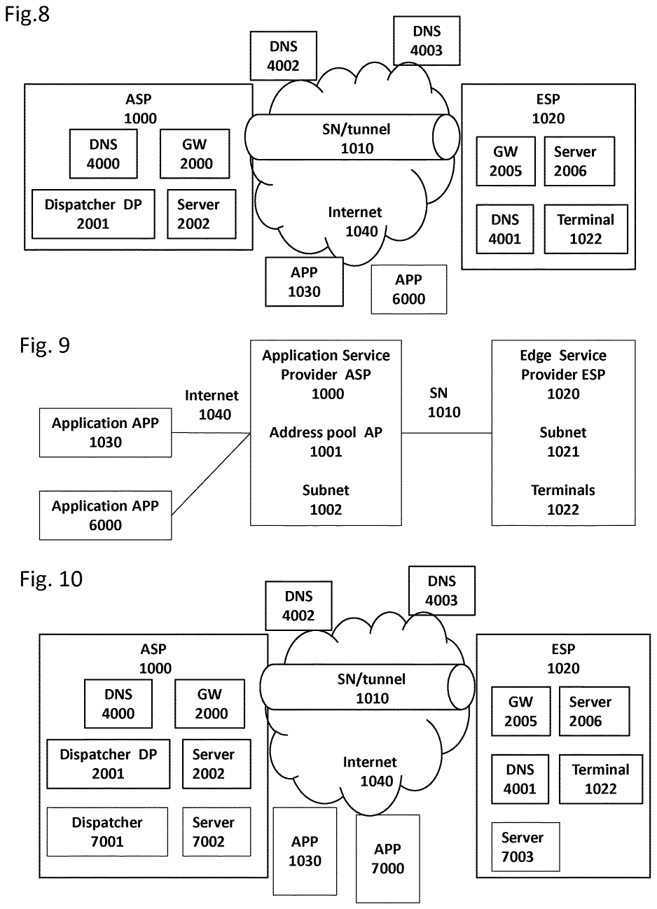

FIGS. 8 and 9 show a complex network system that includes not just one, but multiple application sources APP, and in this case, a second application APP 6000 is specifically introduced as a new application in the system. This configuration shows how the system can flexibly support multiple applications while maintaining efficient data processing and optimized network communications. The system design allows application service providers (ASPs) and edge service providers (ESPs) to efficiently manage and distribute content from multiple sources, ensuring that users receive stable and responsive services.

There is 2dn APP as APP 6000 in the system.

ASP 1000 with server 2002 is preloaded with content from APP 6000.

ESP 1030 with server 2006 is preloaded with content from APP 6000.

APP 6000 has registered the public IP address from ASP 1000 to APP 6000 and the address reachable by DP 2001. APP 6000 has registered the public IP address and domain name in DNS 4002 and 4003. DNS 4000 can obtain the IP and domain name of APP 6000 from DNS 4002 and 4003. The IP and domain name of APP 6000 are set on DNS 4001 of ESP 1020 by manual or automatic transmission. Terminal 1022 in ESP 1020 can obtain the IP and domain name of APP 6000 from DNS 4001. SN 1010 provides the reachable route and path between the IP and domain of APP 6000 and the subnet 1021 of ESP 1020 through ASP 1000, which is called the external route between APP 6000 IP and subnet 1021. APP 6000 uses server 2002 to preload content to ASP 1000, which then uses server 2006 to load the content to ESP 1020. APP 6000 has a tracking record of the content in ASP 1000 server 2002, ASP 1000 public IP address to APP 1030 public IP address and DP 2001 address.

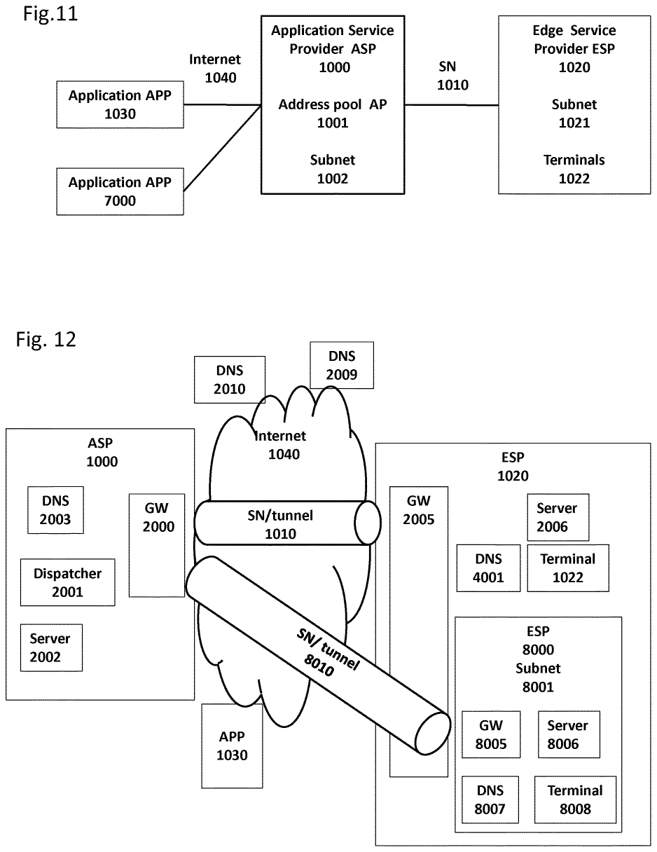

As shown in FIGS. 10 and 11, for the second application source APP such as APP 7000, there are dedicated servers and dedicated dispatchers in ASP 1000 and ESP 1020. Unlike the first application source APP 1030, the second application source APP 7000 requires dedicated resources to ensure the security or management of its content. These resources include a dedicated ASP server 7002 added to ASP 1000 and a dedicated ESP server 7003 added to ESP 1020. The dedicated server preloads the content from APP 7000.

The dedicated dispatcher DP 7001 is added to ASP 1000 and includes the address of subnet 1021 and the address of the dedicated ESP server 7003 in the subnet in its records. The content check process of APP 7000 is the same as described above. ASP 1000 registers the public IP address of APP 7000 and the address of the dedicated dispatcher DP 7001 with APP 7000 to ensure that the terminal can obtain the correct content according to the request. In the DNS system, the public IP address and domain name of APP 7000 are registered in DNS 4002 and DNS 4003. DNS 4000 can obtain the IP address and domain name of APP 7000 from DNS 4002, and then provide it to the terminal 1022 of ESP 1020 through DNS 4001. SN/Tunnel 1010 provides routing between the IPs and domains of APP 7000 and ESP 1020 subnet 1021 through ASP 1000, which is called external routing between APP 7000 IP and subnet 1021.

Terminal 1022 obtains the IP address of APP 7000 from DNS 4001 by sending a request to the domain name of APP 7000. The request then passes through SN 1010, ASP 1000, and finally reaches APP 7000. APP 7000 sets a redirection to the IP address of the dedicated dispatcher DP 7001 in the subnet 1002 of ASP 1000 through an HTTP data packet. When ASP 1000 receives the data packet, the data packet is transmitted to ESP 1020 through SN 1010 and finally reaches terminal 1022. Terminal 1022 processes the redirection and resends the request to the dedicated dispatcher DP 7001 through SN 1010. Dedicated dispatcher DP 7001 determines whether terminal 1022 is located within the subnet 1021 based on its IP address, and sets a redirection to the address of the dedicated ESP server 7003 in the subnet 1021 on the HTTP data packet. Finally, the data packet returns to GW 2000 of ASP 1000 and reaches terminal 1022 through SN 1010. Terminal 1022 handles the redirection and sends a request to dedicated ESP server 7003, thus completing the data transfer.

The specific example is applied to the mini portal/playlist service. APP 7000 preloads or clears the content in the dedicated ASP server 7002 in ASP 1000 and the dedicated ESP server 7003 in ESP 1020. The dedicated ESP server 7003 builds and maintains a list of content titles, and generates a mini portal page for the content stored therein, in which the content name and URL are paired to form an accessible entrance. In the HLS (HTTP Live Streaming) streaming video service, the mini portal page also contains the name of the playlist file and its storage path so that the terminal can obtain the streaming content. When the terminal 1022 initiates a request to APP 7000, the traffic will be redirected to the dedicated ESP server, which will send the mini portal page to the terminal 1022. The terminal 1022 browses and selects the required content in the mini portal page. After selection, the terminal 1022 sends a content request containing the URL to the dedicated ASP server 7003. After receiving the request, the dedicated ASP server 7003 will return the requested content to the terminal 1022 according to the URL of the content, and record the selection of the terminal 1022 on the mini portal page and the security verification process.

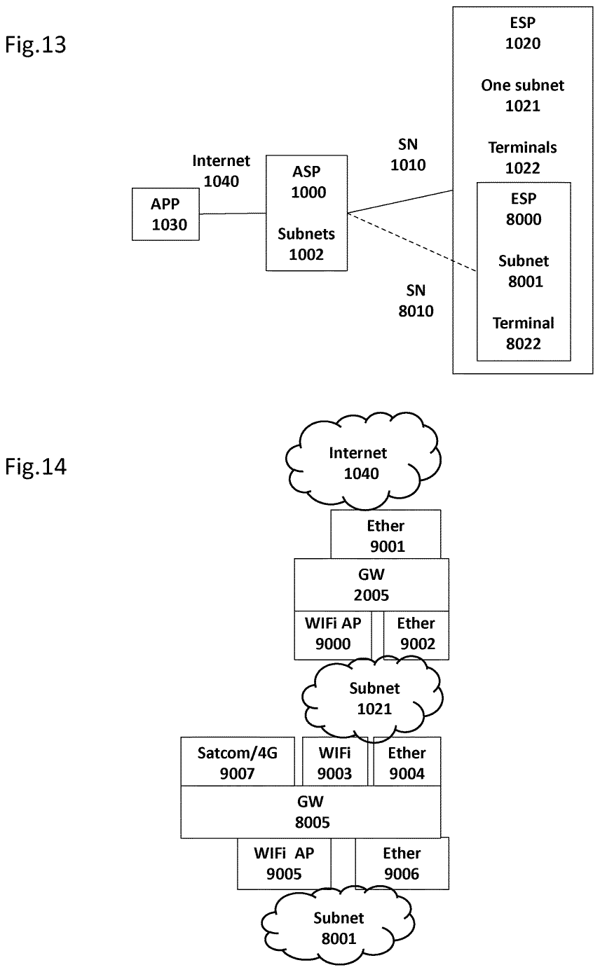

As shown in FIG. 12-14, in the network architecture, the second ESP 8000 is designed as a submodule embedded inside the ESP 1020, usually installed on a carrier with mobility characteristics, such as an airplane, train, or ship. This design allows the ESP 8000 to synchronize and update data through a high-speed and cost-effective connection when it is close to the ESP 1020, such as an airport, train station, or port.

ESP 8000 is located inside ESP 1020, just like a terminal inside ESP 1020. ESP 1020 is located at airports, train stations, ports, and has fast, low-cost fiber optic networks. Server 8006 can quickly get content updates from ASP 1000. ESP 8000 can be installed on planes, trains, and ships, and use slow and expensive satellite wireless Internet or mobile 4G/5G. Server 8006 is slow and expensive to get content updates from ASP 1000. When ESP 8000 arrives at the airport, train station, port, GW 8005 connects to ESP 1020 GW 2005 via WiFi, Ethernet, and low-cost fast Internet. ESP 8000 GW 8005 connects to ESP 1020 GW 2005, and GW 2005 assigns an address in subnet 1021. DNS 8007 is served by DNS 4001. ESP 1020 includes GW 2005, ESP server 2006, DNS 4001, terminal 1022, and ESP 8000. They are reachable in subnet 1021.

GW 2005 has interfaces to Internet 1040 and subnet 1021, and routes to subnet 1021, Internet 1040, and SN 1010. GW 8005 has interfaces to subnet 1021, subnet 8001, and routes to subnet 1021, subnet 8001, and SN 8010 through Internet 1040 and subnet 1021.

ESP 8000 server 8006 is preloaded with content from APP 1030. Dispatcher DP 2001 has a record of the address of subnet 1021, the address of server 2006 in subnet 1021, and the address of subnet 8001, the address of server 8006 in subnet 8001. ESP 8000 connects subnet 8001 to the Internet 1040 using the IP address on GW 2005.

The source NAT in GW 8005 is located on the interface to subnet 1021. The NAT holes are open for destinations to ASP 1000's subnet 1002 and also open for destinations to APP 1030. The packets established by the SN 8010 tunnel, with a destination address of ASP 1000's subnet 1002, a destination address of APP 1030, and a source address of subnet 8001, enter GW 2005, do not match the GW 2005 SN 1010 external route or internal route, and are sent to the Internet 1040. The NAT of GW 2005 translates them to the source IP of the Internet on GW 2005.

ASP 1000 GW 2000 returns the data packet with the destination address being the Internet IP address of GW 2005. GW 2005's NAT restores the data packet with the destination address being the 8001 subnet address. GW 2005 routes the data packet to GW 8005.

SN 8010 tunnel build to ASP 1000 via WiFi fiber optic internet.

SN 8010 does not use SN 1010 via subnet 1021 and Internet 1040.

SN 8010 provides routes between ASP 1000 subnet 1002 and ESP 8000 subnet 8001. These routes are internal routes between subnet 1002 and subnet 8001.

SN 8010 provides routing between APP 1030's IP and domain and ESP 8000's subnet 8001 through ASP 1000, which is called external routing between APP 1030's IP and subnet 8001.

Terminal 8008 requests the content datagram packet of APP 1030, enters GW 8005, SN 8010 external routing, and is redirected to dispatcher DP 2001. Dispatcher DP 2001 redirects to dispatcher DP 8001. Dispatcher DP 8001 redirects the request to server 8006.

Terminal 8008 sends a datagram to a destination IP outside the SN 8010 route and enters gateway GW 8005. It does not match the SN 8010 route. The source NAT in gateway GW 8005 converts the datagram source address to the address of the interface to subnet 1021 and sends it to gateway GW 2005.

In this highly dynamic network architecture, ESP 8000, as a subsystem embedded in ESP 1020, allows ESP 8000 to efficiently synchronize data in mobile environments such as airplanes, trains or ships using network resources in static environments such as airports, train stations or ports.

ESP 8000 Server 8006 updates content from ESP Server 2006 via low cost fast WiFi/Ethernet at airports, train stations, ports.

Gateway GW 2005 has interface 9001 to the Internet 1040, WiFi AP 9000 to subnet 1021, and Ethernet 9002 to subnet 1021.

Gateway GW 8005 has many WAN network interfaces, a high cost slow Satcom/4G interface 9007 connected to the Internet 1040, a low cost fast WiFi 9003 connected to a subnet 1021 and Ethernet 9004.

The gateway GW 8005 monitors the status of the WiFi interface. When the WiFi interface 9003 is turned on within the range of the airport, station, or port, the GW obtains the address from the subnet 1021. If the routing cost metric of the WiFi interface 9003 of the GW 8005 is the lowest, the gateway GW obtains the address from the subnet 1021. If the routing cost metric of the WiFi interface 9003 of the gateway GW 8005 is the lowest, the datagram automatically prioritizes the route of the WiFi interface 9003. The SN 8010 tunnels through the WiFi fiber optic Internet to the ASP 1000 to automatically update the tunnel parameters.

ESP 8000 has a record of associating the address of server 8006 with subnet address 1021. Based on the subnet prefix of the WiFi 9003 IP address, ESP 8000 obtains the IP address of server 2006. Server 8006 manually or automatically updates the content from server 2006. Server 8006 sends a datagram to the address of server 2006, enters GW 8005, does not match the SN 8010 route, the source NAT in GW 8005 converts the source address of the datagram to the address of the interface to subnet 1021, sends GW 2005, and reaches server 2006. Server 2006 returns the content data packet to the interface address of subnet 1021 of GW 8005, the source NAT in GW 8005 restores the destination address to the address of server 8006, and updates the content of server 8006.

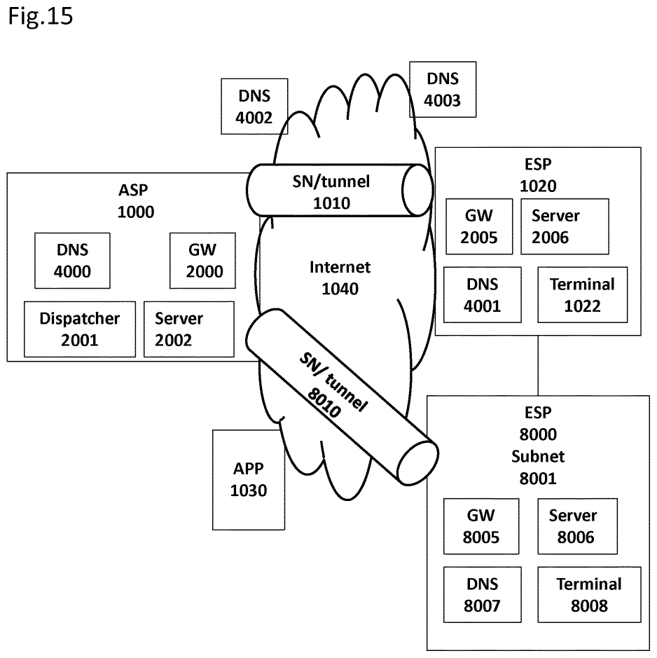

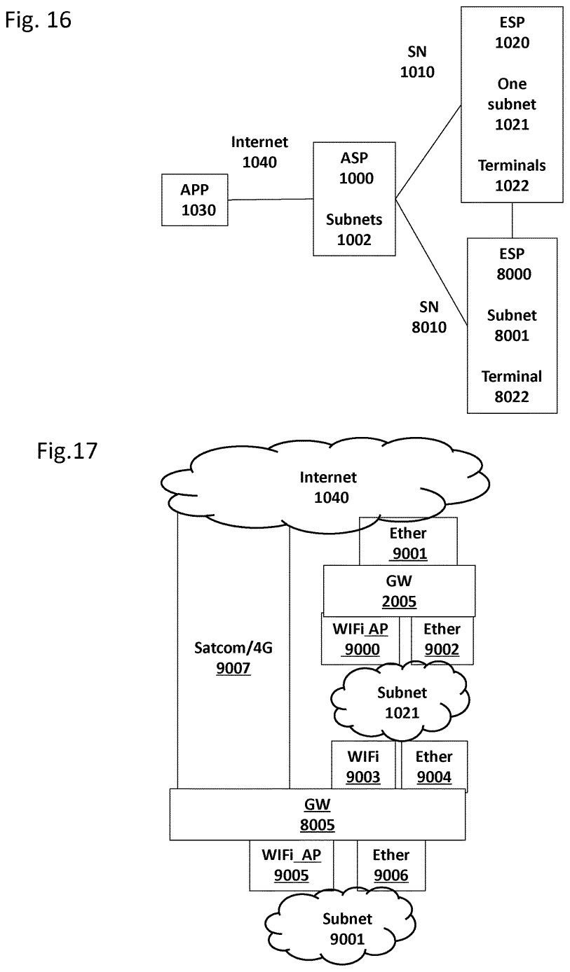

As shown in FIG. 15-17, in airports, stations, ports, and other places, multiple ESP devices (such as ESP 8000 and ESP 1020) are connected via WiFi or Ethernet, and ESP 8000 is also connected to the Internet via satellite or 4G. SN 8010 remains unchanged to ensure network connectivity between devices.

The ESP 8000 is connected to the WiFi access point (WiFi AP 9000) via the WiFi interface 9003 and then to the Internet via the gateway GW 2005. In addition, the ESP 8000 with satellite/4G connection can also connect to the Internet via GW 8005. GW 8005 is responsible for monitoring the status of the WiFi interface 9003. When the device enters the coverage area of the WiFi AP 9000, the WiFi interface 9003 will be turned on and the gateway GW 8005 will obtain an IP address through the subnet 1021.

ESP 8000 will query the IP address record of server 2006 associated with subnet 1021 based on the IP address subnet prefix of WiFi interface 9003, and ESP 8000 will obtain the IP address of server 2006. Server 8006 will obtain the content from server 2006 and send the content data packet to GW 8005. GW 8005 will modify the source address to the address of WiFi interface 9003 of subnet 1021 through source NAT (network address translation), and the data packet will then be forwarded to GW 2005 and reach server 2006, obtain the content and return to ESP 8000.

When ESP 8000 needs to update its content, it can obtain server content through high-speed Internet connection (through ESP 2 or ESP 3) to other ESP devices (such as ESP 2, ESP 3) located in stations, airports or terminals. The update process maintains the connection method of low-speed tunnel VPN and finds and updates content through the association record of geographic location information or IP address prefix with server IP address.

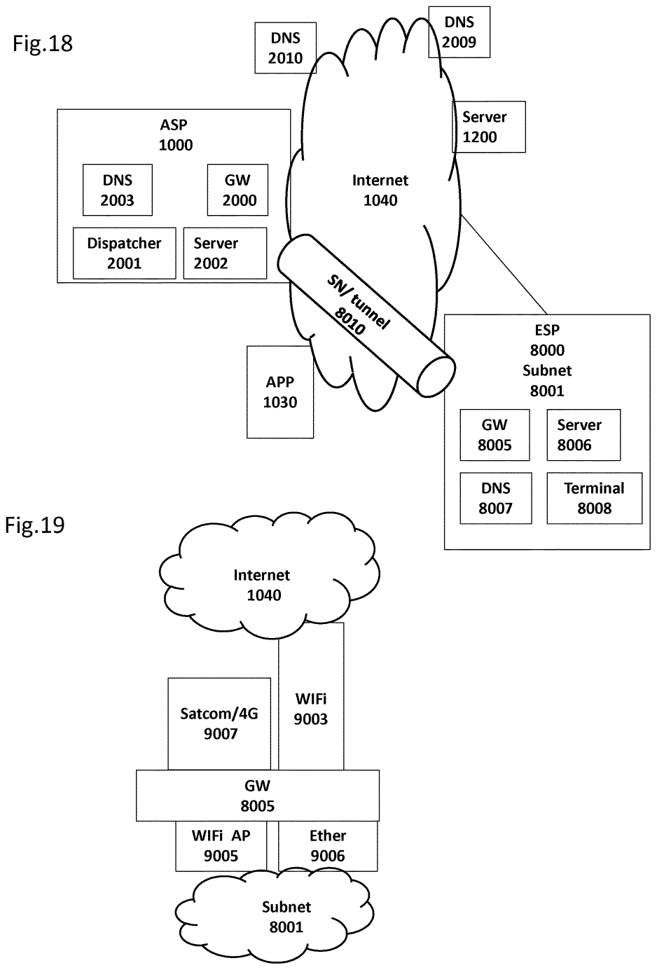

As shown in FIG. 18-19, in some places such as airports and stations, if there is no ESP device available, but only high-speed and low-cost WiFi fiber network, ESP 8000 and GW 8005 devices will switch to WiFi Ethernet connection to replace high-cost satellite or 4G link. At this time, SN 8010 will establish a connection with ASP 1000 through WiFi fiber Internet, and GW 8005 will continuously monitor the status of the WiFi interface. When the device enters the WiFi coverage of the airport, station or port, WiFi interface 9003 is automatically turned on. GW 8005 obtains the address through subnet 1021. If the routing cost (metric) of WiFi interface 9003 is the lowest, the data message will give priority to the path of WiFi interface 9003. When SN 8010 reaches ASP 1000 through WiFi fiber Internet, it will automatically update the tunnel parameters to ensure a stable connection.

Server 8006 located in ESP 800 can update the content from server 2002 in ASP 1000 manually or automatically. The update process is as follows:

Server 8006 sends a datagram to the server 2002 address of ASP 1000, enters through GW 8005, matches the SN 8010 route, continues to be forwarded to GW 2000, and finally reaches server 2002.

Server 2002 returns the content data packet, which passes through GW 8005 and is resent to the address of server 8006, thereby updating the content in server 8006.

At the same time, in nearby places such as stations and airports, ESP 8000 can also obtain updated content through server 1200. Server 1200 is connected to the local area network (LAN) of the station or airport through the Internet 1040 to provide updated content of APP 1030. To find the nearest server 1200, search by IP address prefix or other information, the specific method is as follows:

ESP 8000 has a pre-stored record of association between the server 1200 IP address and the Internet 1040 IP addresses of stations, airports, etc. ESP 8000 compares the IP address subnet prefix of the WiFi interface 9003 with the Internet 1040 IP address of GW 8005 to find the server 1200 IP associated with it.

ESP 8000 can also find the geographical location association record with the IP address of server 1200 based on location information such as GPS, Beidou, Galileo, etc. When approaching a station, airport, etc., ESP 8000 identifies and selects the nearest server 1200 for content update through location information.

Server 1200 is a server with the domain name www.xxx.com, which stores and updates the content of APP 1030 and provides update services through server 2002 of ASP 1000.

The specific process of the server 8006 updating the content from the server 1200 is as follows:

The Internet 1040 near the station, airport or terminal includes the LAN of the station, airport or terminal. The server 1200 connects to the Internet 1040 near the station, airport or terminal and obtains the IP address of the Internet 1040. The IP address may have geographic location information. The server 1200 stores and updates the content of the APP 1030 through the server 2002 of the ASP 1000. At the station, airport or terminal, the ESP 8000 needs to find the nearest server 1200 and store and update the content of the APP 1030 through the high-speed optical fiber Internet.

(1) ESP 8000 has a pre-stored record of the association between the server 1200 IP address and the Internet 1040 IP address of the station, airport, or terminal. ESP 8000 obtains the nearest server 1200 IP address by comparing the address association record with the Internet 1040 IP address of the gateway 8005, such as the WiFi 9003 IP or the 9003 IP address subnet prefix.

(2) ESP 8000 has pre-stored location information (GPS, Beidou, Galileo, base station location system) and the record of association with the nearest 8000 server IP. When ESP 8000 is close to a station, airport or terminal, it reads its own location information and compares the location information range with the record of association with the 1200 server IP. ESP 8000 finds the nearest 1200 server IP.

(3) Server 1200 is a server of the domain name www.xxx.com. Its IP address and domain name are registered in DNS 2010 2009. ESP 8000 is connected to the fiber optic high-speed network at the station airport terminal GW 8005 to connect to the Internet (WAN), WiFi, Ethernet, 5G, and obtains the new address assigned by Internet 1040 as the external address (WAN). DNS 2010, 2009 updates the IP of www.xxx.com in DNS 8007 and the nearest server 1200 according to the new address assigned by Internet 1040 of ESP 8000. Server 8006 sends a datagram to DNS 8007 to find the server IP of the domain name www.xxx.com and obtains the IP address of the nearest server 1200.

ESP 8000 View high-speed network connections Internet (WAN), WiFi, Ethernet, 5G network is connected.

Server 8006 sends the datagram destination address to the IP address of server 1200. The datagram enters GW 8005 and does not match the internal and external routes of SN 8010. The source NAT in GW 8005 converts the datagram source address server 8006 IP address into the address of the interface to the Internet 1040, sends it to the Internet 1040, and reaches server 1200.

Server 1200 returns the content data packet to the interface IP address of Internet 1040 of GW 8005. The source NAT in GW 8005 restores the destination address of the data packet to the IP address of server 8006, and updates the content of server 8006.

The flow chart and block diagram in the accompanying drawings show the possible architecture, function and operation of the system, method and computer program product according to multiple embodiments of the present disclosure. In this regard, each square box in the flow chart or block diagram can represent a part of a program segment or instruction, and a part of a program segment or instruction includes one or more executable instructions for realizing the logical function of the specification. In some alternative implementations, the function marked in the square box can also occur in a sequence different from that marked in the accompanying drawings. For example, two continuous square boxes can actually be executed substantially in parallel, and they can also be executed in the opposite order sometimes, depending on the function involved. It should also be noted that each square box in the block diagram and/or flow chart, and the combination of the square boxes in the block diagram and/or flow chart can be realized by a special hardware-based system that performs the function or action of the specification, or can be realized by a combination of special hardware and computer instructions.

The embodiments of the present disclosure have been described above, and the above description is exemplary, not exhaustive, and is not limited to the disclosed embodiments. Many modifications and changes will be apparent to those of ordinary skill in the art without departing from the scope and spirit of the described embodiments. The selection of terms used herein is intended to best explain the principles of the embodiments, practical applications, or technical improvements in the market, or to enable other persons of ordinary skill in the art to understand the embodiments disclosed herein.

I claim the following:

1. A network edge application service system, characterized in that it comprises an application service provider and an edge service provider; the system has its own subnet address pool, assigning unique and fixed subnet address scopes from the address pool to the application service provider and the edge service provider; the application service provider is configured with a fixed Internet address, and the edge service provider is configured with an Internet address; meanwhile, the gateways of the application service provider and the edge service provider are configured with network address translation (NAT) for converting between the subnet addresses and the Internet addresses;
the edge service provider comprises terminals, servers, and the gateway, and performs internal communication based on the fixed subnet address scope of the edge service provider; the application service provider comprises servers, a dispatcher, and the gateway, and performs internal communication based on the fixed subnet address scope of the application service provider;
a network tunnel is established based on the subnet addresses and Internet addresses on the application service provider and the edge service provider, the network tunnel including internal routing; the internal routing adopts a tunnel binding strategy for the intranet, operating on packets whose destination and source addresses are the subnet addresses; the tunnel source endpoint encapsulates the packets for transmission within the tunnel, and the tunnel destination endpoint decapsulates the packets back into packets whose destination and source addresses are the subnet addresses; the tunnel source endpoint and tunnel destination endpoint comprise the application service provider and the edge service provider;
based on the internal routing and internal communication, the terminal's request packet is sent via the internal routing to the dispatcher's subnet address of the application service provider; the dispatcher receives the request packet, processes it, and sets the reply packet to be redirected to the edge server subnet address in the edge service provider, which is transmitted via the internal routing to the terminal of the edge service provider; the terminal's second request packet is sent via the internal communication of the edge service provider to the corresponding server subnet address, obtaining cached data content from the edge server.

2. According to claim 1, the application service system further comprises an application source, the application source having an internet address and preloading data content to the server of the application service provider, which in turn preloads the data content to the server of the edge service provider;
the network tunnel further comprises external routing (split tunnel), the external routing adopting a tunnel binding strategy for the external network, for handling packets whose destination or source address is the Internet address of the application source; the tunnel source endpoint encapsulates the packets for transmission within the tunnel, and the tunnel destination endpoint decapsulates the packets back into packets whose destination or source address is the Internet address of the application source; wherein the tunnel source endpoint and tunnel destination endpoint comprise the application service provider and the edge service provider;
the application source is configured with a dispatcher, for responding the terminal requests data content via the network tunnel, by replying a packet with redirect destination to the dispatcher subnet address of the application service provider; the terminal then requests the corresponding data content based on the redirected destination to the dispatcher subnet address of the application service provider, including:
the terminal of the edge service provider sends a request packet to the application source to obtain the data content;
the request packet is transmitted via the external routing to the application service provider, which converts the source address of the request packet via NAT into the Internet address of the application service provider and sends it to the application source;
the application source, through its internal dispatcher, sets the reply packet to be redirected to the dispatcher subnet address of the application service provider, reaching the application service provider;
through the NAT and external routing of the application service provider, the reply packet reaches the terminal.

3. According to claim 2, the dispatcher of the application service provider stores and records the subnet address scope of the edge service provider and the server subnet address; the dispatcher matches the source address of the request packet with the corresponding subnet address scope of the edge service provider, obtains the corresponding server subnet address of the edge service provider, and sets the reply packet to be redirected to the server subnet address of the edge service provider, returning the reply packet via the internal routing and the edge service provider.

4. According to claim 2, when the server of the edge service provider does not contain the requested data content of the terminal, it requests the data content from the upstream server of the application service provider via the internal routing; the server of the application service provider responds to the request and forwards the data content via the internal routing to the server of the edge service provider, for responding to the terminal's request packet.

5. According to claim 2, the dispatcher of the application source records the data content preloaded to the server of the application service provider, and records the Internet address of the application service provider and the corresponding dispatcher subnet address;
the application source matches the requested data content in the request packet with the content preloaded to the server of the application service provider, then matches the source address of the request packet with the Internet address of the application service provider, obtains the corresponding dispatcher subnet address of the application service provider, sets the reply packet to be redirected to the dispatcher subnet address of the application service provider, and returns the reply packet to the application service provider; when the requested data content does not match the preloaded content in the server of the application service provider, the application source returns the corresponding content packet to the application service provider.

6. According to claim 2, the application service provider further manages the allocation of the subnet address pool; the NAT configured in the gateway of the application service provider converts the terminal's subnet address into the Internet address of the application service provider, or converts the Internet address of the application service provider into the corresponding subnet address of the terminal.

7. According to claim 2, the application service provider and the edge service provider are further configured with corresponding DNS servers, and equipped with application source records for recording the Internet address of the application source, the Internet address including the domain name and IP address of the application source;
the application source record in the DNS server of the application service provider is transmitted manually or automatically to the DNS server of the edge service provider, for the gateways of the application service provider and the edge service provider to encapsulate request packets whose destination address is the Internet address recorded for the application source, and send them via the external routing; meanwhile, when the terminal issues a request packet for the domain name of the application source, the DNS server of the edge service provider looks up the IP address corresponding to the domain name of the application source.

8. The application service system according to claim 2, characterized in that it further comprises a second application source, a dedicated second server of the application service provider and a second dispatcher, and said dedicated second server of the edge service provider; wherein: the second application source preloads data content to the dedicated second server of the application service provider, and the dedicated second server preloads the data content to the dedicated second server of the edge service provider; the dispatcher of the second application source records the Internet address and a second dispatcher subnet address of the application service provider; the second dispatcher of the application service provider records the subnet address range of the edge service provider and a second server subnet address of the edge service provider; meanwhile, a tunnel is used to bind a strategic external network, a second external route is established based on a destination address or a source address being the Internet address of the second application source, the source address end transmits data packets encapsulated in the tunnel, and the data packets are decapsulated via a Network Address Translation (NAT) of a gateway at a tunnel destination address end into data packets where the destination address or the source address is the Internet address of the second application source, wherein the tunnel source address end and the tunnel destination address end include the application source service provider and the edge service provider.

9. The application service system according to claim 8, characterized in that: a request data packet sent by a terminal to the second application source reaches the gateway of the application service provider through the second external route, and after decapsulation, is converted into the Internet address of the application service provider via network address translation to reach the second application source through the Internet; and a second application source record is configured in a DNS server of the application service provider and is transmitted to a DNS server of the edge service provider manually or automatically.

10. The application service system according to claim 2, characterized in that: the edge service provider is provided with a plurality of network connection interfaces configured with corresponding network addresses, wherein the network connection interfaces include WiFi, Ethernet, and satellite 4/5G networks; the WiFi and the Ethernet are used for connecting to high-speed fiber-optic Internet, the satellite 4/5G network is used for connecting to low-speed Internet, and a route for the network connection interface used for connecting to the high-speed fiber-optic Internet is set to have priority.

11. The application service system according to claim 10, characterized in that the system further comprises an external server for caching server content of the application service provider, wherein: the edge service provider records an association between the network address connected to the high-speed fiber-optic Internet and the external server address; the edge service provider further records an association between geographical location information and the external server address; based on any one of the items, a corresponding external server address is matched according to the network address and the association record, and the edge service provider server updates the data content with the external server through the network connection interface.

12. The application service system according to claim 11, characterized in that: the server of the edge service provider sends a request data update packet to the external server through the gateway of the edge server based on the subnet address; if the gateway of the edge server does not match a network tunnel routes, the source address is converted into the network address of the network connection interface connected to the high-speed fiber-optic Internet via network address translation of the gateway, and then the request data packet is sent to the corresponding external server address for updating the server content of the edge service provider.

13. The application service system according to claim 10, characterized in that: the external server is provided with an Internet address, and a domain name and an IP address thereof are registered in the DNS server; after the server of the edge service provider acquires the network address of the network connection interface connected to the high-speed fiber-optic Internet based on the gateway, it searches for the domain name to which the external server belongs in the DNS server to find the corresponding IP address of the external server.

14. The application service system according to claim 10, characterized in that: it further comprises a second edge service provider connected to the high-speed fiber-optic internet and having a fixed or dynamic network address; a gateway of the second edge service provider is connected to the gateway of the first edge service provider via works WiFi, the first edge service provider is to the high-speed fiber-optic internet and the application service provider, and a subnet address of the server of the second edge service provider is set as the external server address in the association record of the external server in the first edge service provider.

15. The application service system according to claim 14, characterized in that: the server of the second edge service provider responds to the request data packet for content update from the server of the edge service provider; the gateway of the edge service provider converts the source address of the request data packet into a subnet address of the edge service provider within the second edge service provider via network address translation, and sends the request data packet to the gateway of the second edge service provider; at the gateway of the second edge service provider, the destination address of the request data packet is the subnet address of the server of the second edge service provider, and the source address is the subnet address of the edge service provider within the second edge service provider; based on an internal route that does not match the tunnel of the second edge service provider, the data packet is sent to the second edge server subnet address; and the server of the edge service provider obtains the server content update of the second edge service provider.

16. The application service system according to claim 10, characterized in that: the gateway of the edge service provider sets the route for the network interface connecting to the high-speed fiber-optic internet to have priority; the system reconstructs a high-speed tunnel, a high-speed internal route, and a high-speed external route; or the gateway of the edge service provider sets the route priority of the network interface connecting to the high-speed fiber-optic internet to be the same, and the tunnel uses original network interface address parameters to maintain the tunnel, the internal route, and the external route unchanged.

17. A network-edge application service method, characterized in that: it comprises an application service provider, an edge service provider, and an application source. A subnet address pool owned by the system assigns unique and fixed subnet address scopes to the application service provider and the edge service provider. The application service provider is configured with a fixed Internet address, and the edge service provider is configured with an Internet address. Meanwhile, the gateways of the application service provider and the edge service provider are configured with Network Address Translation (NAT) for address translation between the subnet addresses and the Internet addresses;
the edge service provider comprises terminals, servers, and the gateway, and performs internal communications based on the edge service provider's fixed subnet address scope;
the application service provider comprises servers, a dispatcher, and the gateway, and performs internal communications based on the application service provider's fixed subnet address scope;
a network tunnel is established based on the subnet addresses and Internet addresses of the application service provider and the edge service provider. The network tunnel includes an internal route. The internal route adopts a tunnel-binding policy for the internal network and operates on packets whose destination address and source address are subnet addresses. At the tunnel source endpoint, such packets are encapsulated and transmitted through the tunnel. At the tunnel destination endpoint, the packets are decapsulated into packets whose destination address and source address are the subnet addresses. The tunnel source endpoint and tunnel destination endpoint include the application service provider and the edge service provider;
the application source has the internet address;
the server of the application service provider and to the server of the edge service provider preloaded and stored data content from the application source;
the network tunnel further includes an external route (split tunnel). The external route adopts a tunnel-binding policy for the external network and is used to process packets whose destination address or source address is the Internet address of the application source. The tunnel source endpoint encapsulates such packets and transmits them through the tunnel, and the tunnel destination endpoint decapsulates the packets into packets whose destination address or source address is the Internet address of the application source;
the application source is provided with the dispatcher, which responds to terminal requested the data content through the external route of the network tunnel and the Internet; the source address of a received request packet is the internet address of the application service provider; the dispatcher sets a redirection destination in a the reply packet and returns the reply packet to the internet address of the application service provider;
the terminal of the edge service provider sends a first request packet to the application source to obtain the data content from the application source; the first request packet is transmitted through the external route to the application service provider; the application service provider translates the source address of the first request packet into its own internet address through NAT and sends the packet to the application source; the application source dispatcher configures a first redirection destination in the first reply packet and returns the first reply packet to the application service provider. The first reply packet reaches the terminal through the NAT and external route of the application service provider and edge service provider;
the terminal receives and processes the first reply packet with first redirect destination; the terminal sends a second request packet to the first redirection destination.

18. According to claim 17, characterized in that: application source dispatcher configures first redirection destination in the first reply packet to the subnet address of dispatcher in the application service provider and returns the packet to the application service provider; and the first reply packet reaches the terminal through the NAT and external route of the application service provider and edge service provider; the terminal receives and processes the first reply packet with first redirection destination to the subnet address of the dispatcher in the application service provider; the terminal sends a second request packet through the internal route to the dispatcher subnet address of the application service provider;
the dispatcher in the application service provider receives and processes the second request packet and configures a second reply packet with second redirection destination to the subnet address of edge server in the edge service provider.

19. According to claim 18, characterized in that: the terminal receives and processes the second reply packet with second redirection destination to the subnet address of the edge server in the edge service provider;
the terminal then sends a third request packet, to the corresponding edge server subnet address based on the subnet of the edge service provider, thereby obtaining the data content that has been pre-cached and stored on the edge server.

20. A method comprising:
sending, by a terminal of an edge service provider, a first request packet toward an application source through an external route of a network tunnel;
translating, by an application service provider, a source address of the first request packet by network address translation and forwarding the first request packet to the application source;
returning, by the application source, a first reply packet identifying a first redirection destination;
sending, by the terminal, a second request packet to the first redirection destination through an internal route of the network tunnel;
returning, by a dispatcher of the application service provider, a second reply packet identifying an edge server of the edge service provider as a second redirection destination; and
sending, by the terminal, a third request packet to the edge server to obtain cached data content.
